(19) United States
(12) Patent Application Publication
(10) Pub. No.: US 2019/0195695 A1
(43) Pub. Date: Jun. 27, 2019

(54) TEMPERATURE ENVIRONMENTAL SENSORS ON PALLET

(71) Applicant: Walmart Apollo, LLC, Bentonville, AR (US)

(72) Inventor: Andrew B. Millhouse, Gilbert, AZ (US)

(21) Appl. No.: 16/115,767

(22) Filed: Aug. 29, 2018

Related U.S. Application Data
(60) Provisional application No. 62/551,822, filed on Aug. 30, 2017.

(51) Int. Cl. G01K 1/02; B65D 19/38; G08B 21/18

(52) U.S. Cl. CPC G01K 1/024; B65D 2519/0086; G08B 21/182; B65D 19/38

(57) ABSTRACT

Described in detail herein is a system for the detection and notification of abnormal pallet temperature fluctuation. An exemplary system includes a pallet, an ambient air temperature sensor, an item temperature sensor, an indicator light, and an electronic device. The electronic device receives temperature readings from both the ambient air temperature sensor and the item temperature sensor and compares the temperature readings against a known set of temperature thresholds corresponding to the items on the pallet. Following a determination of an unacceptable variation from a threshold, the electronic device may provide a notification through the indicator light. The notification may correspond to the criticality of the threshold passed.

### CROSS-REFERENCE TO RELATED PATENT APPLICATION

This application claims priority to U.S. Provisional Application: 62/551,822 filed on Aug. 30, 2017, the content of which is hereby incorporated by reference in its entirety.

### BACKGROUND

Items moving through the supply chain are tracked during transit. Some items that are temperature-sensitive have additional shipping and/or storage criteria relating to the temperature of the item. Compliance with this additional criteria must be established during storage and/or transit.

### SUMMARY

In one embodiment, an electronic device is attached to a pallet. The electronic device is coupled to an item temperature sensor and an ambient air temperature sensor. Periodic measurements of the item and ambient air are collected by their respective temperature sensors. The electronic device receives from a server a list of threshold temperatures that correspond to the spoilage temperatures of the products loaded on the pallet. The electronic device then determines based on the periodic measurements against the thresholds, whether an alert needs to be transmitted. Based on the thresholds crossed, the alert may be modified to indicate a high or lower sense of urgency.

In one embodiment, an electronic device is attached to a pallet. The electronic device is coupled to an item temperature sensor and an ambient air temperature sensor. Periodic measurements of the item and ambient air are collected by their respective temperature sensors. The electronic device forwards the periodic measurements to a server. The server retrieves a list of threshold temperatures from a database that correspond to the spoilage temperatures of the products loaded on the pallet. The server then determines based on the periodic measurements against the thresholds, whether an alert needs to be transmitted. Based on the thresholds crossed, the alert may be a notification on a mobile device.

### BRIEF DESCRIPTION OF DRAWINGS

Illustrative embodiments are shown by way of example in the accompanying drawings and should not be considered as a limitation of the present disclosure:

FIG. 1 is a block diagram illustrating a deployment of a system for the detection and notification of abnormal pallet temperature fluctuation according to an exemplary embodiment.

FIG. 2 is a block diagram illustrating a distributed system for delivery of temperature fluctuation alerts according to an exemplary embodiment.

FIG. 3 is a flow chart illustrating a process for the detection and notification of abnormal pallet temperature fluctuation according to an exemplary embodiment.

FIG. 4A is an activity diagram demonstrating the detection and notification of abnormal pallet temperature fluctuation according to an exemplary embodiment.

FIG. 4B is an activity diagram demonstrating the detection and notification of abnormal pallet temperature fluctuation according to another exemplary embodiment.

FIG. 5 is a block diagram illustrating an exemplary electronic device suitable for use in an exemplary embodiment.

### DETAILED DESCRIPTION

Described in detail herein is a system for the detection and notification of abnormal pallet temperature fluctuation.

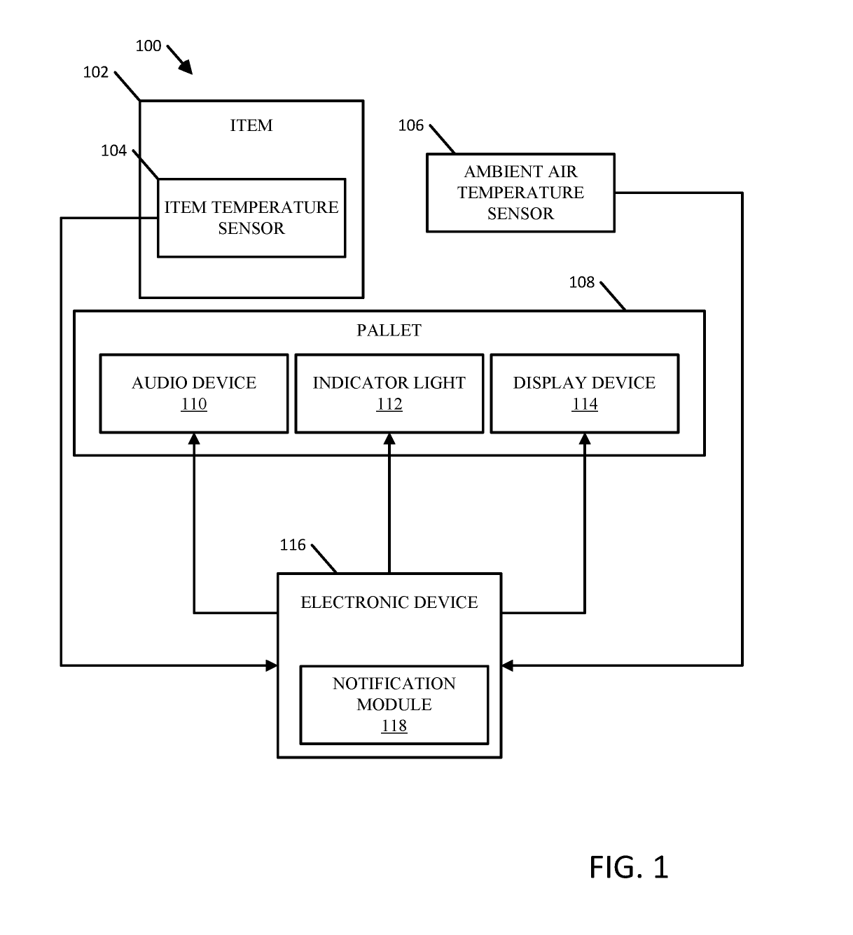

FIG. 1 is a block diagram 100 illustrating a deployment of a system for the detection and notification of abnormal pallet temperature fluctuation according to an exemplary embodiment. In this embodiment, an electronic device 116 is communicatively coupled to a pallet 108 which hosts item 102. The pallet 108 may be any pallet used in industry for the transport of item 102 from one location to another. Exemplary electronic devices 116 include but are not limited to, a small computing device equipped with a processor such as a smartphone, tablet or laptop computer with communication interfaces operable to receive temperature values from temperature sensors. The electronic device 116 may also include touch sensitive input devices. The exemplary electronic device 116 may include communication interfaces operable to interface the electronic device with light indicator devices, auditory alert devices, and display devices. An embodiment of the electronic device 116 may take the form of an Internet of things (IoT) device. Advantages of IoT devices include the utilization of well known operational software packages, low power consumption, and s small footprint. In one embodiment, electronic device 116 is physical integrated into pallet 108. In another embodiment, electronic device 116 is physically separate from pallet 108 but communicatively coupled to temperature sensors, indicator lights and/or display surfaces associated with pallet 108.

Item 102 may take the form of an item capable of being shipped on a pallet. The item 102 may have specific storage temperature thresholds which correlate with the marketability of the item. For instance, if the temperature of item 102 goes beyond a minimum threshold, the item may still be marketable, but with a more limited shelf life. If the item 102 temperature goes beyond a maximum threshold, the item 102 may no longer be marketable and may be removed from the supply chain. The item 102 may include food goods, as well as other goods that require temperature stable environments. As discussed further herein, sets of threshold values corresponding to different types of items may be stored in a database accessible to electronic device 116.

Associated with the item 102 is an item temperature sensor 104. The item temperature sensor 104 may be affixed to, or otherwise in contact with the item 102. The affixation/contact may be internal to the item itself or to the item 102 packaging. The item temperature sensor 104 may be communicatively coupled to the electronic device 116. The communicative coupling may take the form of a wired or wireless connection between the item temperature sensor 104 and the electronic device 116. Wireless connection may be supported by underlying wireless telecommunication protocols including but not limited Wi-Fi®, Bluetooth®, Near-field Communication (NFC), and Zigbee®. The item temperature sensor 104 monitors the temperature associated with the item itself, and in one embodiment reports that temperature to the electronic device 116 on a periodic basis. In another embodiment, the item temperature sensor 104 continually reports the temperature to electronic device 116.

Also associated with the pallet 108 is an ambient air temperature sensor 106. The ambient air temperature sensor 106 may be affixed to the pallet 108 in a manner that allows it to monitor the temperature of the ambient air surrounding the pallet, which may be different from the temperature of the item 102. Alternatively, the air temperature sensor 106 may be physically separate but located so as to monitor the temperature of the ambient air surrounding the pallet 108. Similar to the item temperature sensor 104, the ambient air temperature sensor 106 may be communicatively coupled to the electronic device 116 by means of wireless or wired communication. The underlying wireless telecommunication protocols for the ambient air temperature sensor 106 may be similar to that of the item temperature sensor 104, although it is not a requirement that the temperature sensors utilize the same communication protocol. The ambient air temperature sensor 106 monitors the ambient air temperature on or near the pallet, and reports that temperature in one embodiment to the electronic device 116 on a periodic basis. In another embodiment, the ambient air temperature sensor 106 continually reports the temperature to electronic device 116.

In one embodiment there may be a number of notification devices located on or near the pallet 108. The notification devices may include, but are not limited to, an audio device 110, an indicator light 112, and display device 114. Each of the notification devices may be coupled to the electronic device 116 through a wired connection or a wireless connection similar to the item temperature sensor 104 and/or the ambient air sensor 106. The audio device 110 may include hardware and/or software for the processing of sound signals and replay of the sound signals. Sound signals may include simple auditory tones, or more complex human speech replication. The indicator light 112 may include a light source or a multitude of integrated light sources capable of modifying light characteristics including the emitted light in color, intensity, and the frequency of flashing. The indicator light 112 may include hardware and/or software for modifying the light characteristics, or alternatively, the electronic device 116 may include hardware and/or software for modifying the characteristics. A display device 114 may be utilized for displaying an alert notification. The display device 114 may take the form of a cathode ray tube (CRT), light emitting diode (LED) screen, projector, or any other display surface capable of providing a display notification to a user. Additionally, touch screen functionality may be implemented through capacitive, resistive, or other touch screen mechanisms to provide an input device for the user to interact with the display device 114.

Operating on the electronic device 116 may be a notification module 118. The notification module 118 may be software instructions executing on electronic device 116 providing the functionality described herein or alternatively may be implemented in hardware or a combination of software and hardware. As described further herein, notification module 118 may provide the algorithmic support for the processing of any received temperatures from the item temperature sensor 104 or the ambient air temperature sensor 106. In supporting the processing of the received temperatures, the notification module 118 may interface with the audio device 110, the indicator light 112, and the display device 114 and activate them accordingly based on the processed received temperatures.

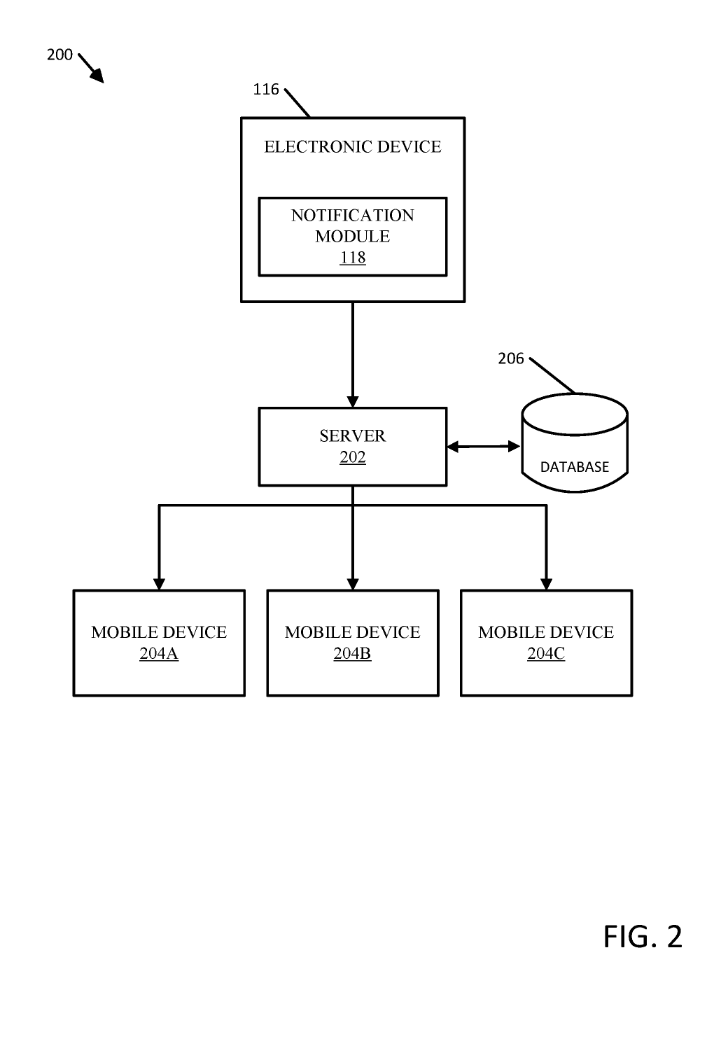

FIG. 2 is a block diagram 200 illustrating a distributed system for delivery of temperature fluctuation alerts according to an exemplary embodiment. In one embodiment, the electronic device 116 may maintain a connection to a server 202. The server 202 may be an individual server, as illustrated herein, multiple interconnected servers, or virtual servers. The connection to the server 202 may be one through wireless communication such as 4G Long Term Evolution (LTE) or Wi-Fi during mobile deployment. Alternatively, the electronic device 116 may be connected to the server 202 through a wired connection using an integrated interface or a docking station for the electronic device 116 that is attached to the server 202 while the pallet 108 is not mobile. It should be appreciated that in another embodiment, the described functionality of the electronic device 116 and server 202 may be combined into server 202 which may be in wireless communication with the temperature sensors, light indicator device, display device, audio device and/or other wireless components associated with pallet 108.

The server 202 may provide data to the notification module 118 through the electronic device 116. The data may include temperature threshold information related to the item 102 on the pallet 108. In another embodiment, the server 202 may provide additional processing to assist the electronic device 116 in providing algorithmic support for the processing of any received temperatures. The server 202 may provide updates to user's mobile devices 204A, 204B, 204C based on the results of the processing of the received temperatures. The updates provided to the mobile devices 204A, 204B, 204C may be in addition to or in lieu of any notifications presented by the audio device 110, the indicator light 112, or the display device 114. The notifications provided to the mobile devices 204A, 204B, 204C may include additional information including pallet location, item description, final destination, and instructions on how to proceed, as the receiving user may not be in the immediate presence of the pallet. Database 206 is accessible to, or operating on the server 202. The database 206 may be implemented across multiple database instances. The database 206 may contain relevant information regarding the items on the pallet, such as, but not limited to, temperature threshold values, origination and destination locations of the goods, and warehouse locations and trailer locations of the pallet.

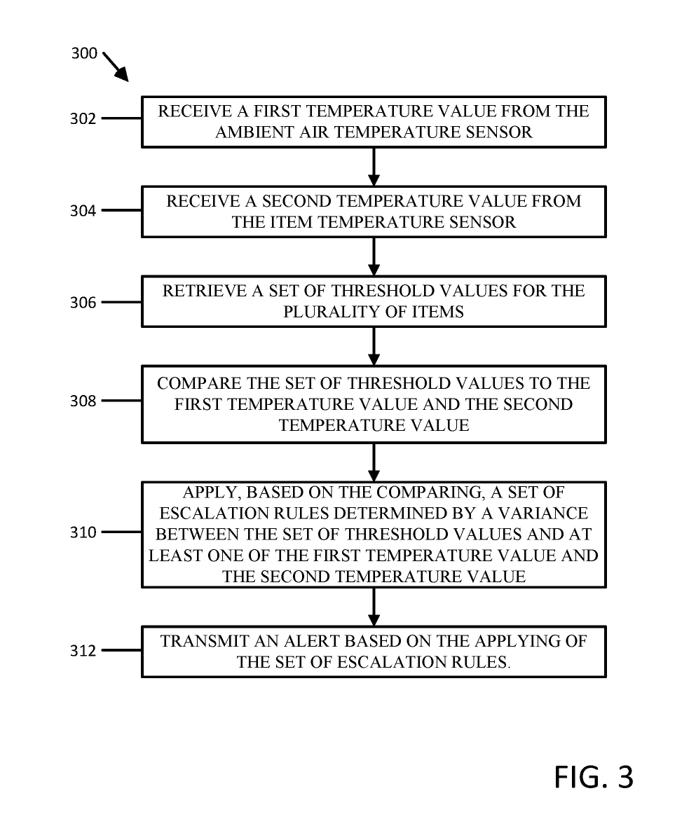

FIG. 3 is a flow chart 300 illustrating a process for the detection and notification of abnormal pallet temperature fluctuation according to an exemplary embodiment.

The sequence begins at block 302 as a first temperature value is received from the ambient air temperature sensor 106. The first temperature value may be periodically received based on a schedule or randomly. In one embodiment, the first temperature value is received following a request from the electronic device 116 to the ambient air temperature sensor 106. In another embodiment, the first temperature value is received by the electronic device 116 based on the data being sent by the ambient air temperature sensor 106 without a request. The first temperature value corresponds to the ambient air temperature surrounding the pallet. For instance, the first temperature value may be a reading of the ambient air temperature in a warehouse when the pallet is located in a warehouse. Alternatively, as another example, the first temperature value may be a reading of the ambient air temperature in a cold storage trailer when the pallet is in transit or from a cold room when the pallet is being stored.

At block 304, a second temperature value is received from the item temperature sensor. The second temperature value may be received independently of the first temperature value, or alternatively the second temperature may be received based on the value of the first temperature value. The second temperature value corresponds to a temperature reading taken from physical contact with an item on the pallet. In one embodiment a temperature reading taken from physical contact may include a reading taken from the item temperature sensor affixed to the exterior of packaging package. Alternatively, the temperature reading may be taken from an item temperature sensor located internally to the packaging of an item or internal to the item itself.

At block 306, a set of threshold values is retrieved for the items on the pallet. The set of threshold values may correspond to varying degrees of spoilage for the items. For example a minimum temperature threshold may be indicative of lessened shelf life of the items, whereas a maximum temperature threshold may be indicative of a complete loss of marketability of the items. In the set of threshold values, there may exist a number of thresholds lower than that of a total loss of marketability, used to alert a user to take various actions to avoid crossing the threshold indicative of a total loss of marketability for the items. The set of thresholds may be included in an item database or multiple databases that include all products applicable to be shipped in the items. Each entry in the database may include an item identifier as well as information regarding the item dimensions, item description, and corresponding temperature thresholds at which a user may be notified to take action.

At block 308, the set of threshold values for an item is compared to the first temperature value and the second temperature value. The threshold values may take a number of forms. For example, the threshold values may include an ambient air temperature threshold and an item temperature threshold. A threshold may be provided with respect to both types of values (e.g. if the ambient air temperature is x then the item temperature must be at least y or the two temperature values cannot be separated by more than x degrees). There may be a number of different thresholds for each item with each threshold associated with an escalation rule indicating an action to be taken in the event the threshold is met or exceeded. For example, a dairy item may have a first temperature value of 30 degrees Fahrenheit, which is associated with the item temperature threshold. The dairy item may also have a second temperature value of 40 degrees Fahrenheit, which is associated with the ambient air temperature. In this example, a crossing of the second temperature value corresponding to ambient air temperature would be worrisome, but not catastrophic. If not the ambient air temperature is not addressed, the first temperature value associated to the item temperature may rise to the point of crossing the threshold. As this value is associated with the item, the crossing of this threshold is more serious.

At block 310, based on the comparing, a set of escalation rules whose applicability is determined by a variance between the set of threshold values and at least one of the first temperature values and the second temperature value is applied. In one embodiment, a threshold violation by the first temperature value alone may prompt the execution of an escalation rule. In another embodiment, a threshold violation by the second temperature value alone may prompt the execution of an escalation rule. In another embodiment, a threshold violation by both the first and second temperature values will prompt the execution of an escalation rule. As there are varying thresholds in the set of thresholds, different escalation rules may be applied based on different thresholds are breached. For example, if a low threshold, indicative of a potential loss of shelf life is detected in either the first temperature value or the second temperature value, lower level escalation rule may be applied. A lower level escalation rule may include a localized notification on the pallet itself as a flashing indication from the indicator light 112. Similarly, a mid-level escalation rule may include a localized notification on the pallet itself by a more rapid flashing indication augmented by an intuitive color change (yellow to red) from the indicator light 112. A high-level escalation rule may include localized notification similar to the mid-level escalation rule, but may include an auditory notification generated by the audio device 110. A critical-level escalation rule may incorporate the features of a high-level escalation rule, and include a notification to a user's mobile device indicating a pallet in distress for which emergency action is required.

At block 312, an alert is transmitted based on the applying of the set of escalation rules. As mentioned above in describing the escalation rules, an alert may take various forms based on which escalation rule is applied. In one embodiment, any level of alert may include an intuitive display of lights by the indicator light 112. For example, no alert may include the display of a solid non-flashing green light indicating no temperature fluctuation over a threshold. Progressing up the set of thresholds may include changes to the indicator light modifying the color presented based on the criticality of the escalation rule. For example, as the criticality increases, the indicator light 112 may change from green, to yellow, to red. Additionally, the intensity of the indicator light 112 may change similarly, from a low intensity to a higher intensity as the criticality increases. Flashing may be used to indicate increases in criticality. A solid light may indicate low criticality, while a rapid flashing light may indicate a high criticality and be designed to attract an immediate response from individuals in the area of the pallet.

Similarly to the display of lights by the indicator light 112, in an embodiment an auditory alert may be presented by the audio device 110. The audio device 110 may produce intuitive noises corresponding to the criticality of the applied escalation rule. For example, low criticality rules may present as subtle beeping and high criticality rules may present as harsher louder tones. Spoken language messages may be presented as well to give a nearby user an indication of the problem as well as the criticality of the problem.

In another embodiment display device 114 may be configured to display a visual representation of the applied escalation rule, and a description of the problem temperatures, as well as suggested remedies. The visual representation may include graphics, text, and video corresponding to the applied escalation rule. Remedies displayed may include but are not limited to the movement of the pallet to a more suitable location up to disposal of pallet contents.

It should be appreciated that embodiments may combine more than one type of alert. For example, the audio device 110 and indicator light 112 may be activated at the same time for increased effect depending on the type of alert.

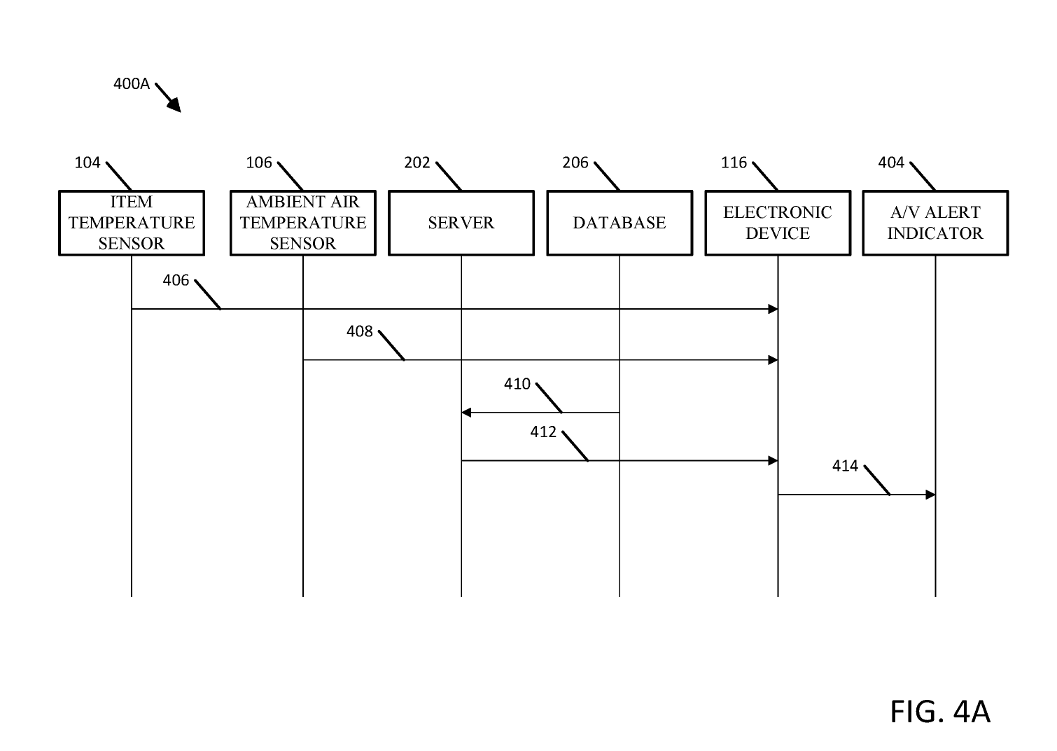

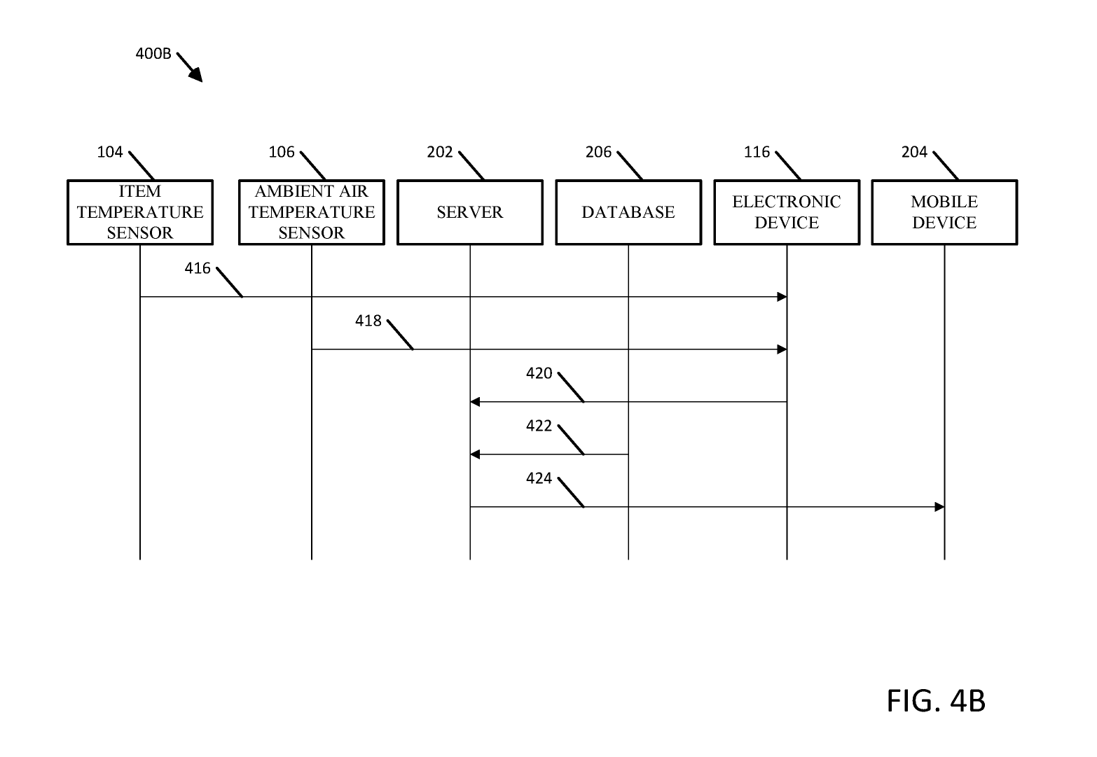

FIG. 4A is an activity diagram 400A demonstrating the detection and notification of abnormal pallet temperature fluctuation according to an exemplary embodiment. In one embodiment components used to detect temperature fluctuations affecting items on a pallet may include an item temperature sensor 104, an ambient air temperature sensor 106, a server 202, a database 206, an electronic device 116, and an audio visual (A/V) alert indicator 404. Messaging between the components may take the form of a binary non-human readable format for ease of processing, or alternatively the formatting my take the form of a human readable format such as JSON or XML encoding. A temperature value may be presented in the form of message 406 to the electronic device 116 from the item temperature sensor 104. A second temperature value may be presented in the form of message 408 from the ambient air temperature sensor 106 to the electronic device 116. A database 206 may provide message 410 to the server 202 containing data relevant to the items or products on the pallet. The data may include temperature thresholds corresponding to each item on the pallet or derived temperature thresholds corresponding to the pallet as a whole based on the items on the pallet. Additionally included may be item descriptions and remedy instructions for saving the item from spoilage. The server 202 may provide message 412 to the electronic device 116 which may include the data about the products on the pallet including temperature thresholds, item descriptions and remedies. Upon the receipt of the message 412, the electronic device 116 may process the data set of the temperature value, the second temperature value, and the escalation rules in accordance with FIG. 3. Based on that processing, the electronic device 116 selects a mechanism of notification available on the pallet and may issues a message 414 corresponding to the results of the processing to the A/V alert indicator 404 instructing the delivery of an audio or visual based alert using one or more of the mechanisms described above.

FIG. 4B is an activity diagram demonstrating the detection and notification of abnormal pallet temperature fluctuation according to another exemplary embodiment. In one embodiment components used to detect abnormal pallet temperature fluctuation may include an item temperature sensor 104, an ambient air temperature sensor 106, a server 202, a database 206, an electronic device 116, and a mobile device 204. As discussed above, any messaging between the components may take the form of a binary non-human readable format for ease of processing, or alternatively the formatting my take a human readable format such as JSON or XML encoding. A temperature value may be presented in the form of message 416 to the electronic device 116 from the item temperature sensor 104. A second temperature value may be presented in the form of message 418 from the ambient air temperature sensor 106 to the electronic device 116.

The electronic device 116 may provide message 420 to the server 202 that may contain the temperature value and the second temperature value. Additional information may be included in message 420, including a unique identifier associated the pallet to which the electronic device 116 is coupled. Location information for the pallet and electronic device 116 may be included in message 420. Database 206 may provide data 422 relevant to the items or products on the pallet to the server 202. Data 422 may include temperature thresholds corresponding to each item on the pallet or derived temperature thresholds corresponding to the pallet as a whole based on the items on the pallet. Additionally included may be item descriptions and remedy instructions for saving the item from spoilage.

The server 202 utilizes the received temperature value and the second temperature value as well as the data received from the database 206 to execute the process displayed in FIG. 3. Upon completing the process described in FIG. 3, the server 202 sends an alert 424 to a mobile device 204. The alert 424 may take a digital form including but not limited to an email, text message, instant message, or a notification in an application. The alert 424 may include the relevant escalation level, affected item descriptions, containing pallet location, and steps to remedy. Steps to remedy may include instructions to the recipient to move the pallet to a more suitable area or discard products or items off the pallet.

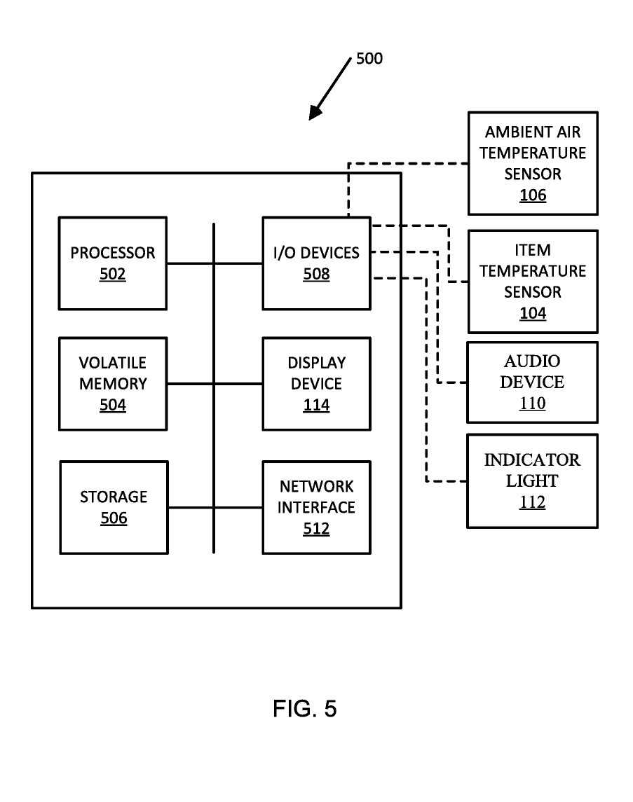

FIG. 5 is a block diagram illustrating an exemplary electronic device suitable for use in an exemplary embodiment. Electronic device 500 can execute the notification module. The electronic device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, volatile memory 504 included in the electronic device 500 may store computer-readable and computer-executable instructions or software (e.g., mobile applications) for implementing exemplary operations of the electronic device 500. The electronic device 500 also includes configurable and/or programmable processor 502 for executing computer-readable and computer-executable instructions or software stored in the volatile memory 504 and other programs for implementing exemplary embodiments of the present disclosure. Processor 502 may be a single core processor or multiple core processors. Processor 502 may be configured to execute one or more of the instructions described in connection with electronic device 500.

Volatile memory 504 may include a computer system memory or random access memory, such as DRAM, SRAM, EDO RAM, and the like. Volatile memory 504 may include other types of memory as well, or combinations thereof.

A user may interact with the electronic device 500 through a display device 114, such as a computer monitor, which may display one or more graphical user interfaces supplemented by I/O devices 508, which may include a multi touch interface, a pointing device, an image capturing device and a reader. Additional I/O devices 508, may include the ambient air temperature sensor 106, the item temperatures sensor 104, the audio device 110, and the indicator light 112.

The electronic device 500 may also include storage 506, such as a hard-drive, CD-ROM, or other computer readable media, for storing data and computer-readable instructions and/or software that implement exemplary embodiments of the present disclosure (e.g., applications). For example, storage 506 may include one or more databases 206 for storing information associated with item pricing information and item packaging information and may be indexed accordingly. The database 206 may be updated manually or automatically at any suitable time to add, delete, and/or update one or more data items in the databases.

The electronic device 500 can include a network interface 512 configured to interface via one or more network devices with one or more networks, for example, Local Area Network (LAN), Wide Area Network (WAN)or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the network interface 512 may include one or more antennas to facilitate wireless communication between the electronic device 500 and a network and/or between the electronic device 500 and other electronic devices. The network interface 512 may include a built-in network adapter, network interface card, PCMCIA network card, card bus network adapter, wireless network adapter, USB network adapter, modem or any other device suitable for interfacing the electronic device 500 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for the detection and notification of abnormal pallet temperature fluctuation comprising:
a pallet configured to hold a plurality of items,
an ambient air temperature sensor configured to detect an ambient air temperature at a location of the pallet,
an item temperature sensor configured to physically contact at least one of the plurality of items to determine an item temperature,
an indicator light physically connected to the pallet,
an electronic device equipped with a processor and communicatively coupled to the ambient air sensor, the item temperature sensor and the indicator light and configured to execute a notification module that when executed:
receives a first temperature value from the ambient air temperature sensor,
receives a second temperature value from the item temperature sensor,
retrieves a set of threshold values for the plurality of items,
compares the set of threshold values to the first temperature value and the second temperature value,
applies, based on the comparing, a set of escalation rules determined by a variance between the set of threshold values and at least one of the first temperature value and the second temperature value, and
transmits an alert based on the applying of the set of escalation rules.

2. The system of claim 1, wherein the alert triggers the indicator light to perform at least one of a modification of a color, a modification of a speed of oscillation of a signal and a modification of an intensity of a signal to correspond to at least one threshold value.

3. The system of claim 1, further comprising:
an audio device integrated in, or attached to, the pallet, the audio device communicatively coupled to the electronic device, wherein the alert triggers a broadcast message or sound by the audio device.

4. The system of claim 3, wherein engaging the alert modifies at least one of a volume level and frequency of a broadcast message or sound from the audio device to correspond to a threshold level.

5. The system of claim 1, further comprising:
a display surface, integrated in, or attached to, the pallet, the display surface communicatively coupled to the electronic device,
wherein the alert triggers a displayed message on the display surface.

6. The system of claim 1, wherein the alert includes instructions to relocate the pallet to a suitable temperature area.

7. The system of claim 2, wherein the alert includes notifications that at least one item on the pallet needs to be discarded and reordered.

8. The system of claim 1, wherein the notification module when executed further:
updates, based on the applying, a database entry to include a record of the alert; and
pushes, based on the updating, a notification containing an alert to a mobile device associated with a user.

9. A method for detection and notification of abnormal pallet temperature fluctuation comprising:
receiving a first temperature value from an ambient air temperature sensor;
receiving a second temperature value from an item temperature sensor;
retrieving a set of threshold values for a plurality of items;
comparing the set of threshold values to the first temperature value and the second temperature value;
applying, based on the comparing, a set of escalation rules determined by a variance between the set of threshold values and at least one of the first temperature value and the second temperature value; and
transmitting an alert based on the applying of the set of escalation rules.

10. The method of claim 8, wherein the alert triggers an indicator light to perform a at least one of a modification of a color, a modification of a speed of oscillation of a signal and a modification of an intensity of a signal to correspond to at least one threshold value.

11. The method of claim 8, further comprising:
an audio device integrated in, or attached to, the pallet, the audio device communicatively coupled to the electronic device, wherein the alert triggers a broadcast message or sound by the audio device.

12. The method of claim 11, wherein engaging the alert modifies at least one of a volume level and frequency of a broadcast message or sound from the audio device to correspond to a threshold level.

13. The method of claim 8, further comprising:
a display surface, integrated in, or attached to, the pallet, the display surface communicatively coupled to the electronic device,
wherein the alert triggers a displayed message on the display surface.

14. The method of claim 13, wherein the alert includes instructions to relocate the pallet to a suitable temperature area.

15. The method of claim 8, wherein the alert includes notifications that at least one item on the pallet needs to be discarded and reordered

16. The method of claim 8, further comprising:
updating, based on the applying, a database entry to include a record of the alert; and
pushing, based on the updating, a notification containing an alert to a mobile device associated with a user.

17. A smart pallet for the detection and notification of abnormal temperature fluctuation, the smart pallet comprising:
an ambient air temperature sensor configured to detect an ambient air temperature at a location of the pallet,
an item temperature sensor configured to physically contact at least one of the plurality of items to determine an item temperature,
an indicator light physically connected to the smart pallet,
a display surface, integrated in, or attached to, the smart pallet;
an audio device integrated in, or attached to, the pallet, and a location sensor,
wherein an electronic device equipped with a processor is communicatively coupled to the ambient air sensor, the item temperature sensor, the indicator light, the display surface and the audio device and is configured to execute a notification module that when executed:
receives a first location value from the location sensor,
receives a first temperature value from the ambient air temperature sensor,
receives a second temperature value from the item temperature sensor,
retrieves a set of threshold values for the plurality of items,
compares the set of threshold values to the first temperature value and the second temperature value,
applies, based on the comparing, a set of escalation rules determined by the variance between the set of threshold values and the first temperature value and the second temperature value, and
transmits an alert based on the applying of the set of escalation rules by triggering at least one of the indicator light, the audio device and the display surface.

18. The smart pallet of claim 17 wherein the electronic device is integrated into the smart pallet.

19. The smart pallet of claim 17, wherein the alert triggers the indicator light to perform at least one of a modification of a color, a modification of a speed of oscillation of a signal and a modification of an intensity of a signal to correspond to at least one threshold value.

20. The smart pallet of claim 17, wherein the alert triggers at least one of a broadcast message or sound by the audio device and a display of a message on the display surface.
